(19) United States
(12) Patent Application Publication
(10) Pub. No.: US 2006/0059152 A1
(43) Pub. Date: Mar. 16, 2006

(54) Browse history presentation system

(75) Inventor: Yasufumi Nakamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/204,236

(22) Filed: Aug. 16, 2005

(30) Foreign Application Priority Data
Aug. 25, 2004 (JP) 2004-245730

(51) Int. Cl. G06F 7/00

(52) U.S. Cl. 707/7

(57) ABSTRACT

A user has been unable to efficiently acquire desired information from a website even if it is a website that the user has browsed at least once before. There is provided an information processing device, which comprises: a browse history analysis portion which extracts information conforming with a predetermined subject from received data of a first device, and corresponding said information to reference data of said received data to store the corresponded data in a storage portion; and an information retrieval portion which receives an information retrieval request sent from a second device, along with a designation of a field subclassed in said predetermined subject, retrieves said storage portion from the information conforming with said predetermined subject, extracts said reference data corresponding to said information, and transmits same to said second device.

### BACKGROUND OF THE INVENTION

1. Field of the Invention

The present invention relates to an information processing device in which information related to a present location or a move destination of a user is retrieved by the user from the browse history of websites that the user has browsed previously, and is displayed to the user, a method of displaying the browse history, and a related program.

2. Description of the Related Art

Today, various information terminals such as a cellular phone, PDA (Personal Digital Assistance), PC (Personal Computer) and the like can be connected to the Internet. A user can freely browse websites established on the Internet by using those information terminals, to collect information. The user can store, in the information terminal, the URL of a website and the title (<TITLE> the content of a tag) of the website that the user wishes to check frequently or that the user does not visit too often but wishes to check again.

The URL and title stored as above are called “bookmark”, and such a function is called “bookmark function”. When accessing the website again, the user can obtain an access to it by selecting the bookmark stored in the information terminal, and can access the target website readily without entering the URL.

Recently, the wireless communication network has been consolidated, so a user has a frequent access to the Internet even from wherever the user is happened to be. Therefore, there has been proposed a conventional technology that enables use of information collected at home or at workplace even from a place where the use is happened to be. For instance, there is proposed a system, information processing device, and the like with which a server at a workplace or at home is accessed from an information terminal brought out to the outside to refer the information (bookmarks, management support information, and the like) stored in the server (See Japanese Published Unexamined Application No. 2001-216408, Japanese Published Unexamined Application No. 2002-24513, and Japanese Published Unexamined Application No. 2003-67328).

Further, as a method of managing bookmarks, there has been suggested a technology in which, when a user registers a bookmark, additional information other than the title of the website is stored so that the registered website can be used efficiently (See Japanese Published Unexamined Application No. 2002-49644).

Therefore, as one of the ways to collect information by using the Internet, for example, in case of collecting information on the vicinity of the present location or information on the vicinity of the destination to go to, the user can store the websites (URLs) of the information at home or the work place. Even from wherever the user is happened to be, he/she can use an information terminal, such as PDA or cellular phone, to reference the bookmarks of these websites, and to acquire the information about the vicinity of the present location and the information about the vicinity of the destination, by using the conventional technology.

### SUMMARY OF THE INVENTION

In the conventional technology, however, even if a plurality of bookmarks that are stored in the workplace PC or home PC can be acquired, it is troublesome to find desired information (for example, information about the vicinity of the present location, or the information about the vicinity of the target area) from among the scattered bookmarks, when the bookmarks are not organized. This is because the user needs to browse and check the contents of the website again when the description thereof is unclear only by the title of the website which is the only information the bookmarks tell.

Further, even if devising the registration method of bookmarks, the website, which had been browsed once but has not been stored as a bookmark, has to be searched by using a search page again. Thus, the website that can be reached only from the link of a certain website cannot be browsed again, unless the user remembers how to access the link of the certain website, or otherwise the website is buried in the large amount of websites.

Consequently, the user sometimes could not efficiently acquire desired information (e.g. information on the present location or the vicinity of the target area) from a website even if it is the website that the user has browsed before. Therefore, an object of the present invention is to provide an information processing device for presenting the website that contains information that the user wishes to obtain, from among the websites that the user has browsed before, while keeping the work load of the user low. Preferably, the object of the present invention is to provide an information processing device that enables the user to obtain information readily even when the user uses an information terminal with low operational performance at a place wherever the user is happened to be.

According to a first aspect of the present invention, the above-described object is to provide an information processing device, including: a browse history analysis portion which extracts information conforming with a predetermined subject from received data of a first device, and relates said information with reference data of said received data to store the related data in a storage portion; and an information retrieval portion which receives an information retrieval request sent from a second device, along with a designation of a field subclassed in said predetermined subject, retrieves the information conforming with said predetermined subject stored in said storage portion, extracts said reference data corresponding to said designated field, and transmits the extracted reference data to said second device.

According to a more preferable embodiment in above aspect of the present invention, said storage portion has stored therein, in advance, a subject recall phrase list containing a phrase that is likely to be followed by a description of the information conforming with said predetermined subject. Further, said browse history analysis portion judges whether or not the phrase contained in said subject recall phrase list is used for a tag name within said received data, and, if used, stores the content of the tag in which the phrase contained in said subject recall phrase list is used for said tag name, as the information conforming with said predetermined subject.

According to another and more preferable embodiment in above aspect of the present invention, said storage portion has stored therein, in advance, the subject recall phrase list containing a phrase that is likely to be followed by a description of the information conforming with said predetermined subject. Also, said browse history analysis portion judges whether or not the phrase contained in said subject recall phrase list is used in said received data, and, if used, stores the contents of the line in which the phrase contained in said subject recall phrase list is used, and/or of the line next thereto, as the information conforming with said predetermined subject.

Moreover, according to a more preferable embodiment in above aspect of the present invention, the information conforming with said predetermined subject is location information for specifying a location, and said field designation is a designation of a predetermined location. Said information retrieval portion retrieves said storage portion on the basis of said location information to extract said reference data corresponding to said predetermined location. Further, according to a more preferable embodiment in above aspect of the present invention, the information conforming with said predetermined subject is time information for specifying a time, said field designation is a designation of a predetermined time, and said information retrieval portion retrieves said storage portion on the basis of said time information to extract said reference data corresponding to said time information.

Furthermore, according to a more preferable embodiment in above aspect of the present invention, said storage portion has stored therein, in advance, a location recall phrase list containing a phrase that is likely to be followed by a description of said location information, latitude/longitude information in which an address and latitude/longitude are corresponded to each other, and range information for determining a retrieval range of the vicinity of said designated location. Said browse history analysis portion judges whether or not the phrase contained in said location recall phrase list is used for a tag name within said received data, and, if used, extracts said address from the content of the tag in which the phrase contained in said location recall phrase list is used for said tag name, converts the extracted address into latitude/longitude on the basis of said latitude/longitude information, and stores the converted result as said location information. And said information retrieval portion receives information for specifying latitude/longitude as a designation of said location, and extracts said reference data corresponding to said retrieval range which is determined based on said range information.

According to a more preferable embodiment in above aspect of the present invention, when receiving information for specifying an address as a designation of said location, said information retrieval portion converts the address specified by the received information into latitude/longitude on the basis of said latitude/longitude information to perform retrieval. Further, according to a more preferable embodiment in above aspect of the present invention, any of a prefecture name, city/town/village name, zip code, facility name, access point name of a wireless LAN, or station name is used as said address.

According to a second aspect of the present invention, the abovementioned object is achieved by providing a program causing a computer to execute: extracting information conforming with a prescribed subject from received data of a first device; relating said information with reference data of said received data to store the related data in a storage portion; receiving an information retrieval request sent from a second device, along with a designation of a field subclassed in said predetermined subject. The program further causing the computer to execute: retrieving the information conforming with said predetermined subject stored in said storage portion, extracting said reference data corresponding to said designated field; and transmitting the extracted reference data to said second device.

Moreover, according to a third aspect of the present invention, the abovementioned object is achieved by providing a browse history presentation method, including: extracting information conforming with a predetermined subject from received data of a first device; relating said information with reference data of said received data to store the related data in a storage portion; and receiving an information retrieval request sent from a second device, along with a designation of a field subclassed in said predetermined subject. The method further includes retrieving the information conforming with said predetermined subject said storage portion; extracting said reference data corresponding to said designated field; and transmitting the extracted reference data to said second device.

According to the present invention, by analyzing a tag or text of a source file, the information conforming with the predetermined subject is corresponded to the URL, which is then accumulated as a browse history, thus appropriate information can be sent as a response to the information retrieval request of the user. Unlike the bookmark function, this accumulation of browse history does not require intervention of a user such as an explicit registration command of the user, thus the burden of the user is light.

Therefore, for instance, the information for specifying a location is extracted from a website that the user has browsed at least once, is then corresponded to the URL and stored as a browse history in the information processing device. Then, by inputting into the information processing device a station name, hotspot name, facility name such as an event site, and the address or the like of the present location, the user can easily obtain a URL of a website that contains information related to the designated location, from the websites that the user has browsed at least once.

Consequently, if the user has browsed, even once, a website containing the information about the designated location, even if the URL is not registered at that time to a bookmark explicitly, the user can easily access the information about the designated location later. Further, unlike the bookmark function, advantages are that the browse history that is accumulated is used even when there is no explicit registration instruction of the user, and that the extraction of the location information is performed automatically, so there is no need to manage the browse history manually. Furthermore, by using a cellular phone equipped with a GPS (Global Positioning System) function, latitude/longitude information of the present location is transmitted by button operation and inputted to the information processing device, thus the input work of the user can be reduced, thereby making it easier for the user to use.

### BRIEF DESCRIPTION OF THE DRAWINGS

FIG. 1 is a configuration example of a browse history presentation system of the present embodiment;

FIG. 2 is a configuration block diagram of a server of the present embodiment;

FIG. 3 is a functional block diagram of the server to explain a concept of the present embodiment;

FIG. 4 is a block diagram for explaining a function of a server 1 of a specific example of the present embodiment;

FIG. 5 is a data configuration example of a location information extraction rule list used in the specific example of the present embodiment;

FIG. 6 is a data configuration example of a location recall phrase list used in the specific example of the present embodiment;

FIG. 7 is a data configuration example of a prefecture name list used in the specific example of the present embodiment;

FIG. 8 is a data configuration example of a city/town/village name list used in the specific example of the present embodiment;

FIG. 9 is a data configuration example of a station name list used in the specific example of the present embodiment;

FIG. 10 is a data configuration example of a zip code list used in the specific example of the present embodiment;

FIG. 11 is a data configuration example of a time information extraction rule list used in the specific example of the present embodiment;

FIG. 12 is a data configuration example of a time recall phrase list used in the specific example of the present embodiment;

FIG. 13 is a data configuration example of a browse history DB used in the specific example of the present embodiment, where A is a main table, B is a location table, and C is a time table.

FIG. 14 is a data configuration example of a hotspot name list used in the specific example of the present embodiment;

FIG. 15 is a data configuration example of a time condition list used in the specific example of the present embodiment;

FIG. 16 is a flow chart for explaining an operation of a browse history analysis portion in the specific example of the present embodiment;

FIG. 17 is a specific example of a source file where a location recall phrase is used for a tag;

FIG. 18 is a specific example of the source file where the location recall phrase is used at a place other than the tag;

FIG. 19 is a flow chart for explaining an operation of the information retrieval portion in the specific example of the present embodiment;

FIG. 20 is an example of an information retrieval screen according to the specific example of the present embodiment;

FIG. 21 is a flow chart for explaining information retrieval processing on the basis of the location information, in the specific example of the present embodiment;

FIG. 22 is a flow chart for explaining retrieval result display processing, in the specific example of the present embodiment; and

FIG. 23 is a screen example of an information retrieval result display screen in the specific example of the present embodiment.

### DESCRIPTION OF THE PREFERRED EMBODIMENTS

Embodiments of the present invention will now be described hereinafter with reference to the drawings. However, technological range of the present invention is not limited to the embodiments and covers the invention descried in the scope of the patent claims and equal components thereof.

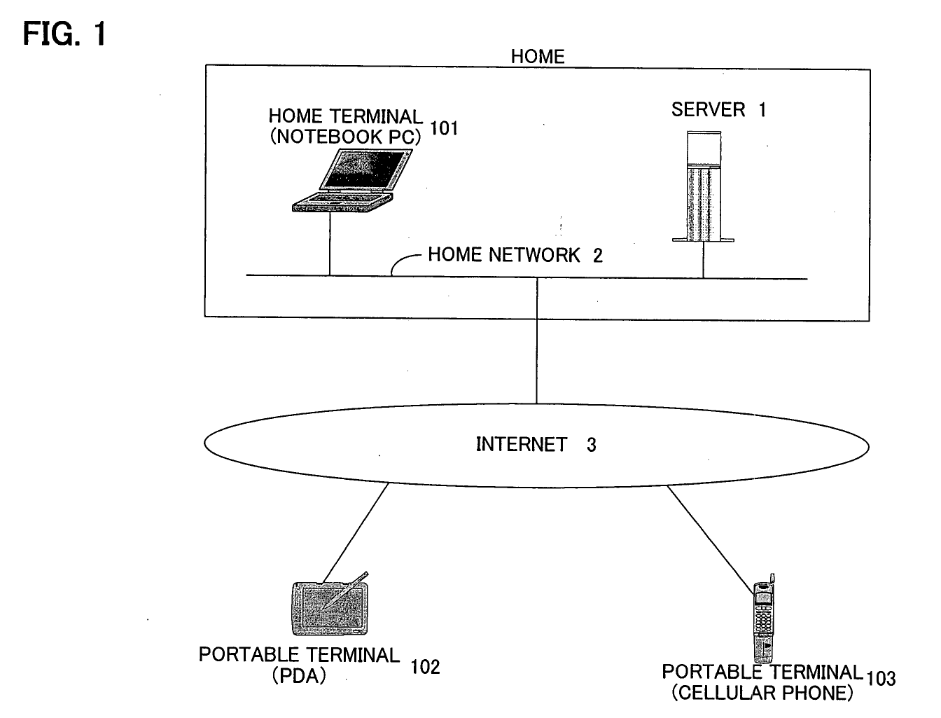

FIG. 1 is a configuration example of a browse history presentation system of the present embodiment. A home terminal 101 is an information terminal used at home or at a work place, and is a notebook PC as shown in FIG. 1. The home terminal 101 is connected to a home network 2 and to an Internet 3 via a router, modem or the like that is not shown in the figure, and a user can browse websites by using the home terminal 101.

Further, a server 1 is connected to the home network 2. This server 1 stores a website browsed using the home terminal 101 as a browse history, and, when the user wishes to browse the same website again afterwards, reads out and display the contents of the browse history, thus fast processing is possible since an access to the Internet 3 does not occur. Unlike a conventional bookmark function, storing the browse history is performed even if the user does not give an explicit instruction for storing (within the limits of the storage capacity of the server 1).

Several methods can be considered to realize such server 1. For example, if the server 1 is a server that functions as a proxy/cash server, the server 1 can store a website that can be browsed using the home terminal 101. In addition, if the server 1 is a server that functions as a router, by monitoring an access made by using the HTTP (Hyper Text Transfer Protocol), the server 1 can store information on the website browsed using the home terminal 101, as a browse history.

The user can also access the Internet 3 even from the place where the user is happened to be. The information terminal (referred to as “portable terminal” hereinafter) to bring when going out is usually made small with portability in mind, and is, as shown in FIG. 1, a PDA 102 and cellular phone 103, for example. The user can use the portable terminal to access the server 1 that is connected to the home network 2 via the Internet.

In the present embodiment, the server 1 extracts information conforming with a predetermined subject from a website that is browsed using the home terminal 101, and accumulates it. The server 1 then receives information for specifying a field that is subclassed in the predetermined subject, the information being designated by the user, the server 1 retrieves, from accumulated browse histories, a website containing information related to the designated field, and transmits a URL list, which is a result of the retrieval, to the portable terminal of the user. Consequently, even if the portable terminal has low operationality, the user can access the related website that he/she has browsed before, by means of the home terminal 101, and can efficiently obtain necessary information, without entering a search phrase, which is cumbersome, or without searching the website again.

The predetermined subject includes, for example, “place”, “time”, “dog” and the like. The field that is subclassed in the predetermined subject includes, in the case of “place”, a specific address, a station name, a zip code, a facility name and the like, in the case of “time”, a specific date and hour or period of time, and further in the case of “dog”, the type of a dog, dog parenting, information on a pet shop and the like.

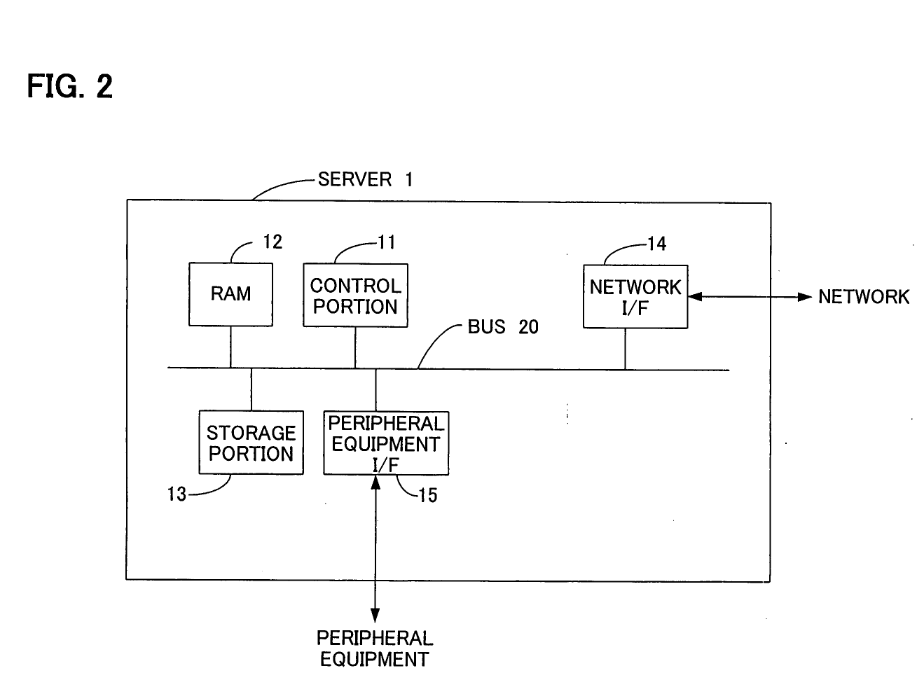

FIG. 2 is a configuration block diagram of the server 1 in the present embodiment. The server 1 in FIG. 2 is a main body portion of a desktop PC, and includes a control portion 11, a RAM (Random Access Memory) 12, a storage portion 13, a network interface (I/F) 14, and an interface (I/F) for connecting the server 1 to peripheral equipment 15. All these are connected via a bus 20.

The control portion 11 has a CPU (Central Processing Unit), which is not shown, and executes a RAM program to control each portion contained in the server 1. The RAM 12 is storage means in which a computation result or program in processing performed by the server 1 is temporarily stored. The storage portion 13 is nonvolatile storage means, such as a hard disk, optical disk, magnetic disk, flash memory or the like, where various types of data and program, such as an OS (Operating System) or the like prior to being read to the RAM, are stored.

The peripheral equipment I/F 15 is an interface for connecting peripheral equipment to the server 1, and includes a USB (Universal Serial Bus) port, PCI card slot, and the like. The peripheral equipment covers a wide range of equipment, such as a printer, TV tuner, SCSI (Small Computer System Interface) audio equipment, memory card reader/writer, network card, wireless LAN card, modem card, keyboard, mouse, display device, etc.

A signal or data transmitted and received via the network 2 (including the Internet 3) is inputted to and outputted from the network I/F 14. The network I/F 14 may be omitted if there is a network card, wireless LAN card, modem card or other communication card that is externally connected via the above-described peripheral equipment I/F 15. Note that when realizing the server 1 using a notebook PC, the main body is equipped with an input portion such as a keyboard, touch pad or the like, and an output portion such as a liquid crystal display or the like, other than what is shown in FIG. 2.

Moreover, the configuration of the information terminal shown in FIG. 1 (including the home terminal and portable terminal) is same as the configuration shown in FIG. 2. However, in the case of the notebook PC 101, PDA 102, and cellular phone 103, the main body is equipped with the input portion such as a keyboard, button, touch pad etc, and a display portion such as a liquid crystal display etc.

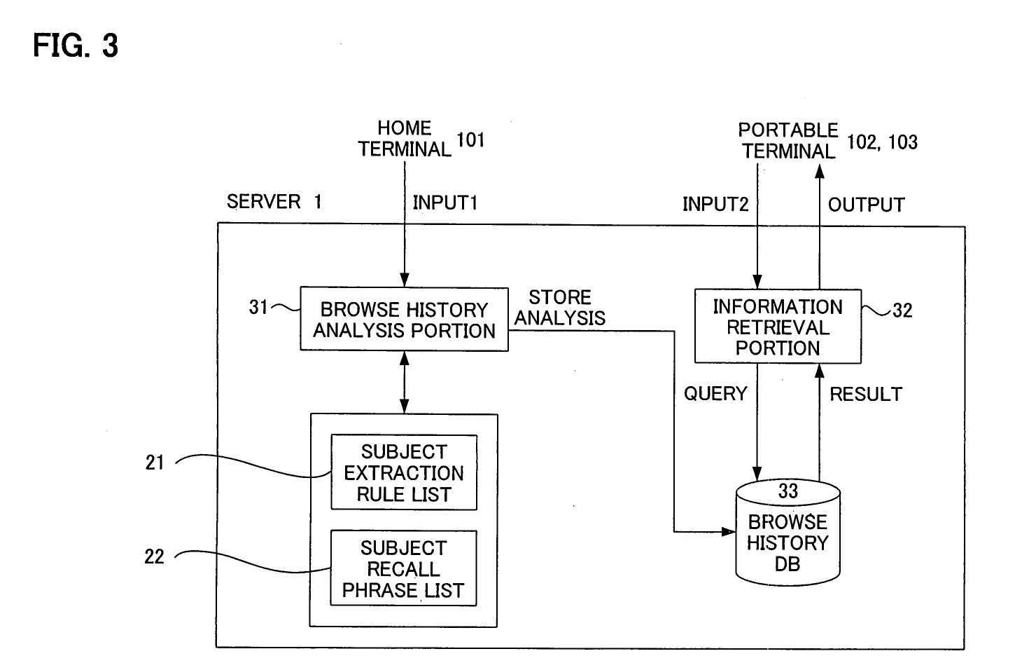

FIG. 3 is a functional block diagram of the server 1 for explaining the concept of the present embodiment. The control portion 11 of the server 1 contains a browse history analysis portion 31 and information retrieval portion 32. These functional portions can be realized as a program that is executed in the unshown CPU equipped in the control portion 11, or can be realized by the hardware.

The storage portion 13 of the server 1 has stored therein a browse history database (hereinafter “browse history DB” for short) 33 for storing a website that has been browsed using the home terminal 101 as a browse history, a subject extraction rule list 21 for extracting information conforming with a predetermined subject (e.g. location information (information indicating a location) or time information (information indicating a time)) from the contents of the browsed website, and a subject recall phrase list 22 containing phrase that is likely to be followed by a description of the information conforming with the predetermined subject in the source file. In addition, the storage portion 13 may also have stored therein various lists that are used for selecting a result to be displayed in response to a request from the user.

The browse history analysis portion 31 receives the URL of the website browsed from the home terminal 101, and a source file (INPUT 1), extracts from the source file information conforming with a predetermined subject, based on the subject extraction rule list 21 and subject recall phrase list 22 to analyze the contents of the information, and then stores the analysis result, URL, source file etc. in the browse history DB 33 (STORE ANALYSIS). Here, “source file” indicates a text file written in a markup language or the like that can be interpreted by the web browser that modifies and display the web page on the information terminal screen.

The information retrieval portion 32 receives an information retrieval request sent from the portable terminal 103, along with information for specifying a field subclassed in the predetermined subject (INPUT 2) (e.g. designation of a location or designation or time), and searches in the browse history DB to see whether or not information matching a condition exists (QUERY). The information retrieval portion 32 then transmits an obtained search result (RESULT) to the output terminal 103 that has transmitted the information retrieval request (OUTPUT).

Consequently, if the browse history display system is used, information about the predetermined subject that is established beforehand is extracted from the website that has been browsed using the home terminal 101, and is corresponded to the URL and accumulated in the server 1. Further, the user inputs the field subclassed in the predetermined subject (specific values or phrases that relate to the predetermined subject) into the server, even from wherever the user is happened to be, whereby the user can easily acquire the URL or the like of the website that the user has browsed before, from among the websites containing the related information, and can display the website by clicking. Therefore, wherever the user is happened to be, he/she can efficiently utilize the information collected at home or at workplace.

Hereinafter, an example in which the predetermined subject is specifically specified will now be explained. The following specific example, the information specifying a location (location information) and information specifying a time (time information) are combined and used as the information conforming with the predetermined subject.

Specifically, the subject is “location” and “time”, and in this specific example, the server 1 extracts descriptions related to “location” and “time” from a website that has been browsed via the home terminal 101, and stores them, and then, when “location” and “time” are designated, transmits the URL or the like of the website which relates to the designated “location” and “time” as the information retrieval request sent from the user to the information terminal that has transmitted the information retrieval request. For the portable terminal used in this specific example, a terminal, which can transmit position information of the terminal to the server 1 by means of the GPS function, is used. Further, the storage portion of the server 1 has stored therein a retrieval range for determining a policy of information selection based on the location information, and a mode for determining a policy of information selection based on the time information.

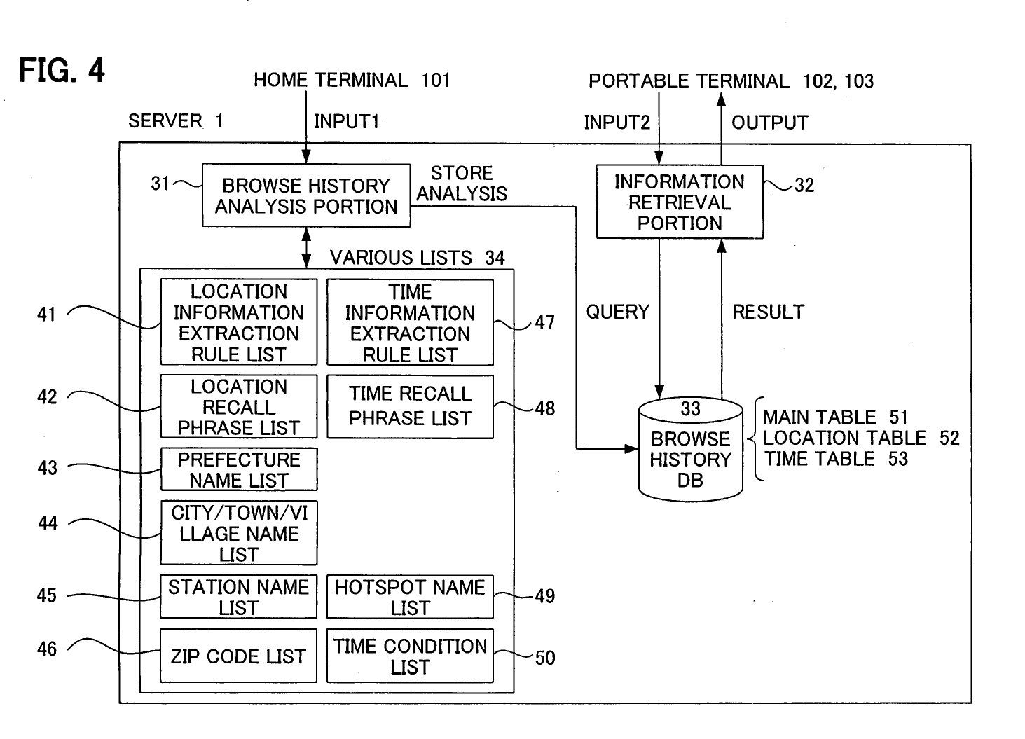

FIG. 4 is a block diagram explaining the function of the server 1 in the specific example of the present embodiment. Same numbers are allocated in the configuration parts that are same as those of FIG. 3, thus the detailed explanation thereof is omitted.

In addition to the browse history DB 33 described in FIG. 3, the storage portion 13 of the server 1 has stored therein various lists 34 that are used for extracting the location information and time information contained in the contents of the browsed website and selecting a result to be displayed in response to the request (information retrieval request) from the user.

The browse history analysis portion 31 receives the URL of the website that has been browsed from the home terminal 101, and the source file (INPUT 1), extracts the location information and time information contained in the source file to analyze the contents of those information, and then stores the analysis result, URL, source file etc. in the browse history DB 33 (STORE ANALYSIS).

The information retrieval portion 32 receives the information retrieval request sent from the portable terminal 103, along with information for specifying a location, the information being obtained by the user (designation of a location) (INPUT 2), and searches in the browse history DB to see whether or not information matching the condition exists (QUERY). The information retrieval portion 32 then transmits an obtained search result (RESULT) to the portable terminal 103 which has transmitted the information retrieval request (OUTPUT). In INPUT 2 the information retrieval portion 32 can receive the information for specifying a time (designation of a time), and present to the user the information that matches the designated time; however, in the following specific example, information that is selected based on a present time is to be presented in accordance with the mode that is set by the time condition list provided beforehand.

The data configurations of the various lists 34 and browse history DB 33 stored in the storage portion 13 of the server 1 will now be described. First, a list to be used for constructing the browse history DB is explained.

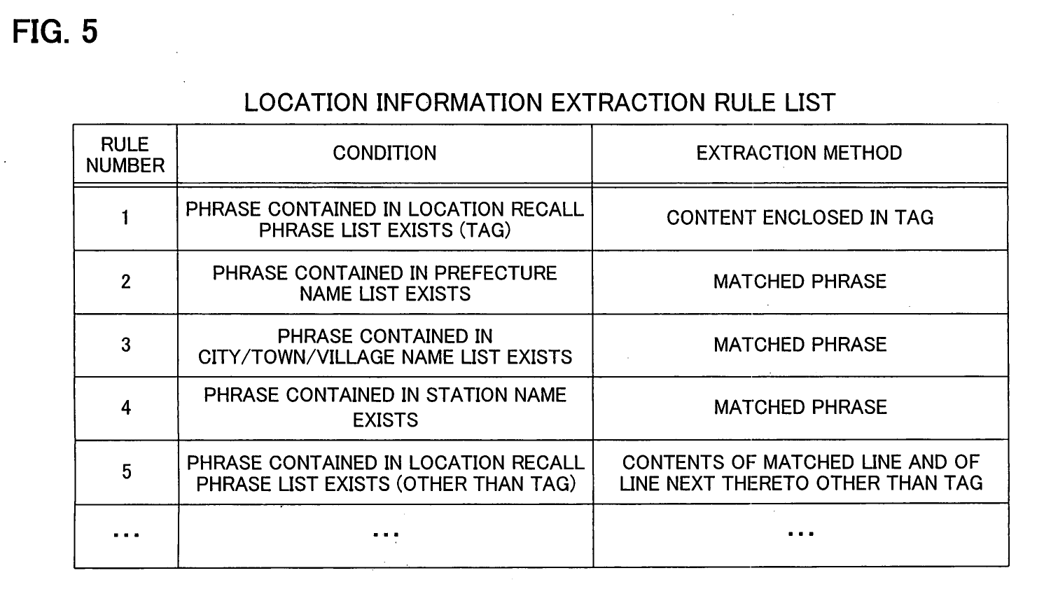

FIG. 5 is a data configuration example of a location information extraction rule list 41 used in the specific example of the present embodiment. The location information extraction rule list 41 in FIG. 5 includes data items, such as “rule number”, “condition”, and “extraction method”. The “rule number” is a number for identifying each rule. When extracting the location information, rules are applied in ascending order of the rule numbers.

The “condition” indicates a condition for extracting the location information from the source file. The “extraction method” indicates a method for specifying the location information when matching the “condition”. For example, in the case of the rule number 1, it is judged whether or not a phrase that is likely to be followed by a description of the location information (location recall phrase) is used as an XML (eXtensible Markup Language) tag in the source file. For example, it is a tag such as <address> xxx </address>. Further, based on the “extraction method” thereof, the contents (xxx) enclosed in the address tag (<address> --- </address>) are extracted as the location information.

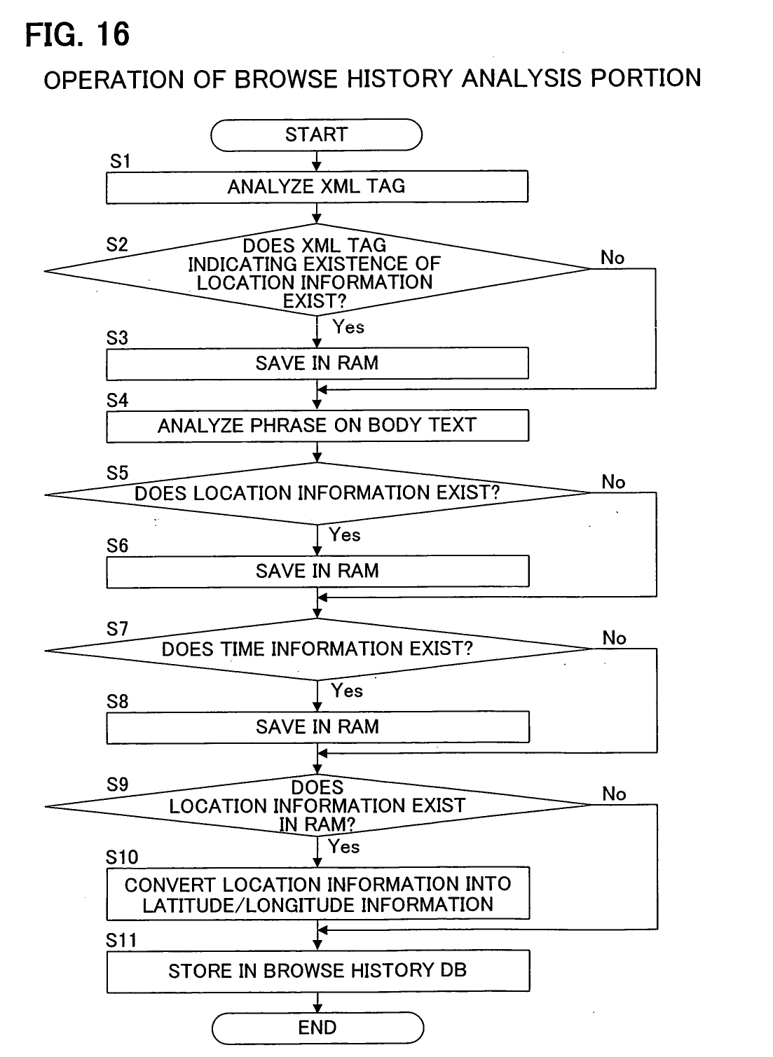

In addition, the location extraction rule list 41 includes the rule for extracting the location information such as the prefecture names, city/town/village names, and station names contained in the source file, or includes a rule for extracting the location information if the location recall phrase at a place other than the tag is written. Note that detailed explanations of the extraction processing of the location information will be provided hereinbelow using FIG. 16.

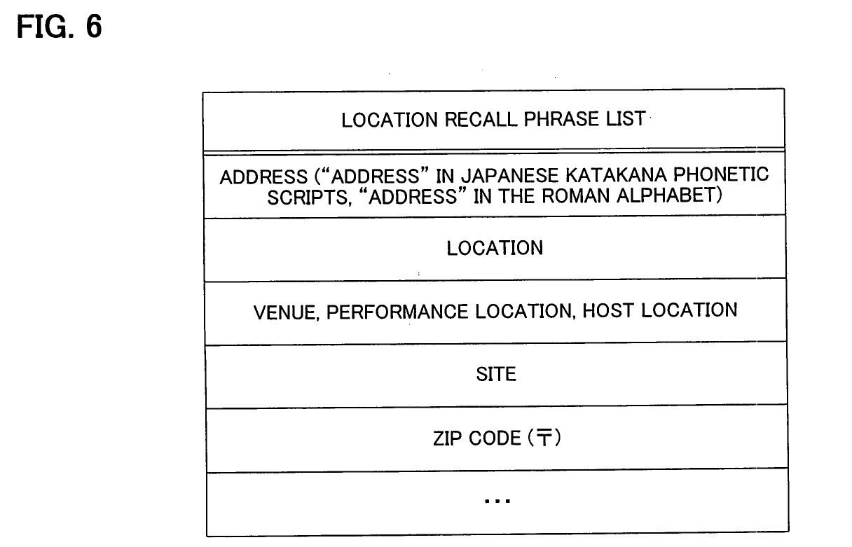

FIG. 6 is a data configuration example of the location recall phrase list 42 used in the specific example of the present embodiment. The location recall phrase is a phrase that is likely to be followed by a description of the location information. For example, if a phrase, “address”, is used in the source file, chances are high that a subsequent description is information specifying a location, such as a detailed address having a block number.

The same can be said for a phrase such as “address” written in Japanese katakana phonetic scripts or in the Kanji charachter. In addition, such phrases as “location”, “venue”, “performance location”, “host location”, “site”, “zip code”, and “ [symbol] ” fall under the category of the location recall phrase. When a new location recall phrase is discovered, the location recall phrase is added to the location recall phrase list 42 and updated, whereby extraction of the location information becomes easier.

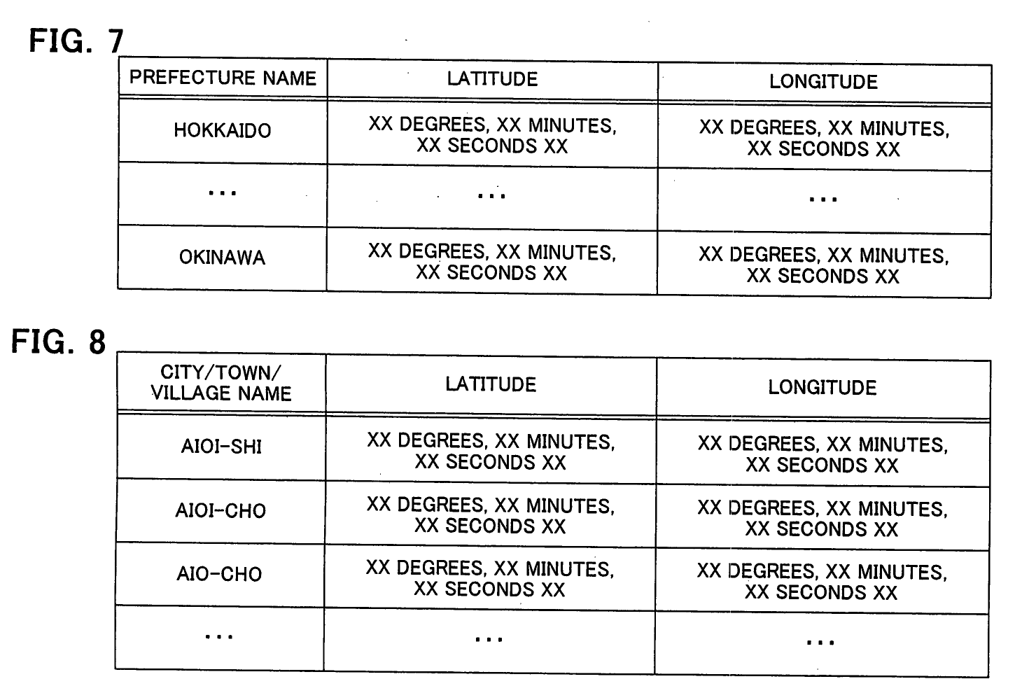

FIG. 7 is a data configuration example of a prefecture name list 43 used in the specific example of the present embodiment. This list is referred to in order to extract location information when prefecture names are included in the source file.

The prefecture name list 43 of FIG. 7 has data items, such as “prefecture name”, “latitude”, and “longitude”. In this specific example, the extracted location information is converted into latitude/longitude and then stored in the browse history DB 33, thus latitude and longitude are corresponded to each prefecture in the list 43. Latitude and longitude corresponding to the prefecture name are determined in advance based on, for example, the address of the prefectural capital.

FIG. 8 is a data configuration example of a city/town/village name list 44 used in the specific example of the present embodiment. This list is referred to in order to extract location information when city/town/village names are included in the source file.

The city/town/village name list 44 of FIG. 8 has data items, such as “city/town/village name”, “latitude”, and “longitude”. In this specific example, the extracted location information is converted into latitude/longitude and then stored in the browse history DB 33, thus latitude and longitude are corresponded to each city/town/village name in the list 44. Latitude and longitude corresponding to the city/town/village name are determined in advance based on, for example, the street address of the city office, or town and village offices.

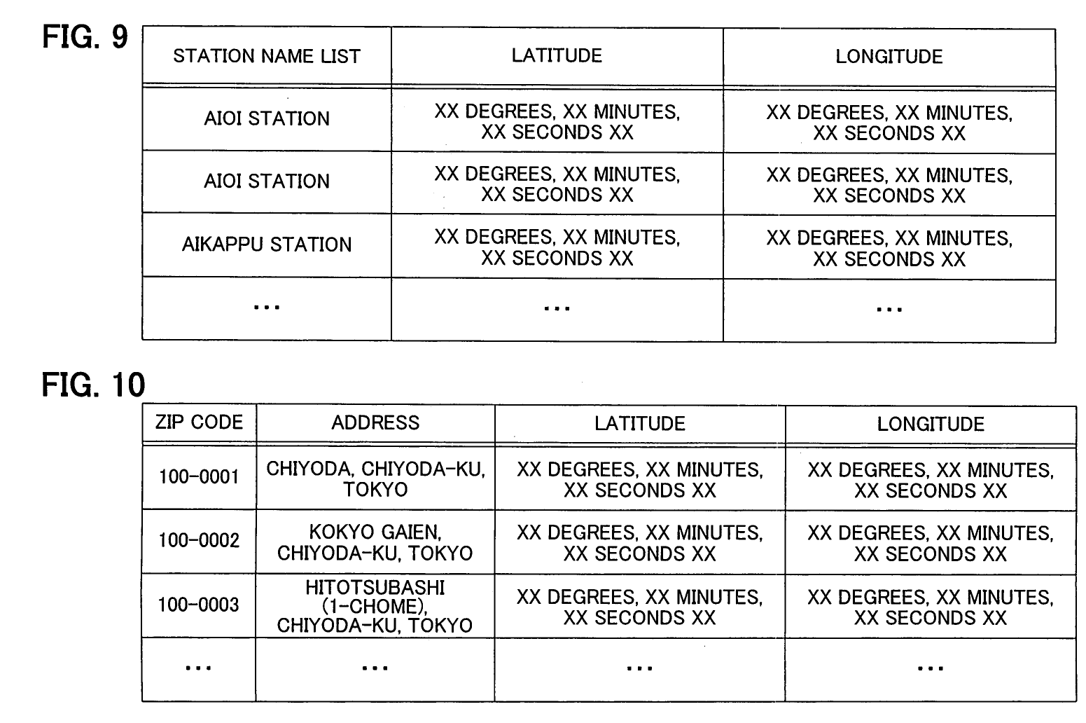

FIG. 9 is a data configuration example of a station name list 45 used in the specific example of the present embodiment. This list is referred to in order to extract location information when station names are included in the source file.

The station name list 45 of FIG. 9 has data items, such as “station name”, “latitude”, and “longitude”. In this specific example, the extracted location information is converted into latitude/longitude and then stored in the browse history DB 33, thus latitude and longitude are corresponded to each station name in the list 45. Latitude and longitude corresponding to the station name are determined in advance based on the street address of the station.

FIG. 10 is a data configuration example of a zip code list 46 used in the specific example of the present embodiment. This list is referred to in order to extract location information when zip codes (or maybe [symbol] ) are included in the location recall phrase list 42 (see FIG. 6).

The zip code list 46 of FIG. 10 has data items, such as “zip code”, “address”, “latitude”, and “longitude”. In this specific example, the extracted location information is converted into latitude/longitude and then stored in the browse history DB 33, thus latitude and longitude are corresponded to each zip code in the list 46. An address without the block number is specified by a zip code, thus latitude and longitude corresponding to the zip code are determined in advance based on this address.

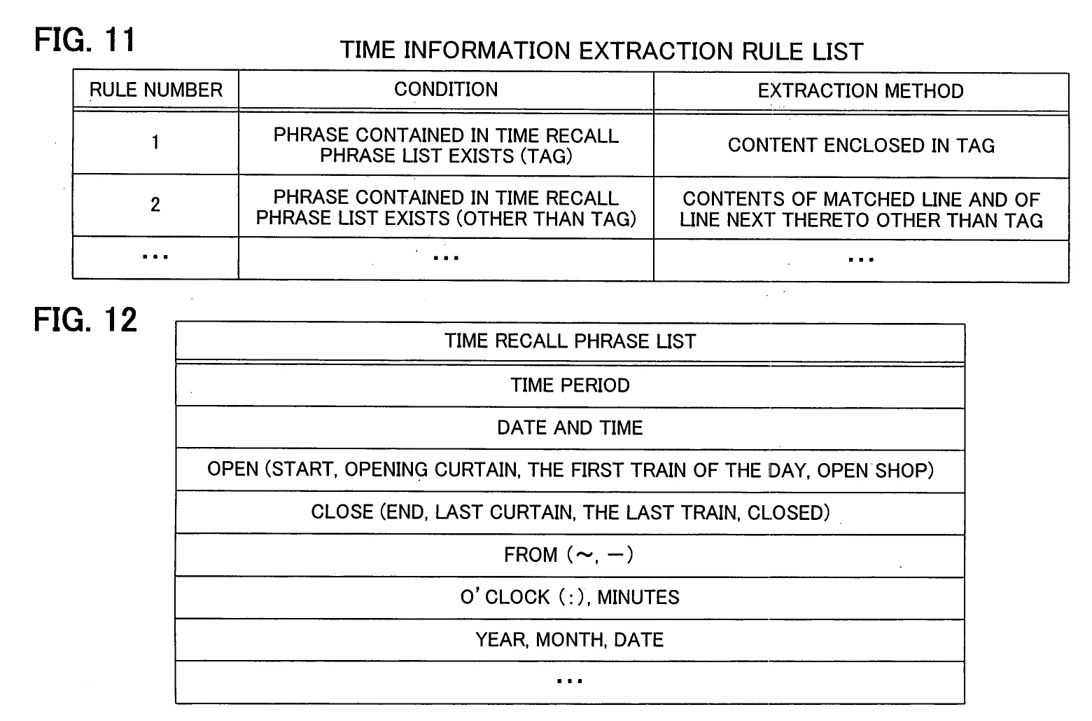

FIG. 11 is a data configuration example of a time information extraction rule list 47 used in the specific example of the present embodiment. In this specific example, time information is extracted in addition to the location information, thereby improving the usability of the browse history presentation system for the user. In other words, by allowing the user to be able to designate a time also, the server 1 can provide more appropriate information to the user.

The time information extraction rule list 47 of FIG. 11 has data items, such as “rule number”, “condition”, and “extraction method”. The “rule number” is a number for identifying each rule. When extracting the time information, rules are applied in ascending order of the rule numbers.

The “condition” indicates a condition for extracting the time information from the source file. The “extraction method” indicates a method for specifying the time information when matching the “condition”. For example, in the case of the rule number 1, it is judged whether or not a phrase that is likely to be followed by a description of the time information (time recall phrase) is used as an XML (eXtensible Markup Language) tag in the source file. For example, it is a tag such as <time period> yyy </time period>. Further, based on the “extraction method” thereof, the contents (yyy) enclosed in the time period tag (<time period> --- </time period>) are extracted as the time information.

In addition, the time information extraction rule liset 47 includes the rule for extracting the time information if the time recall phrase is written at a place other than the tag. Note that detailed explanations of the extraction processing of the time information will be provided hereinbelow using FIG. 16.

FIG. 12 is a data configuration example of a time recall phrase list 48 used in the specific example of the present embodiment. The time recall phrase is, as described above, a phrase that is likely to be followed by a description of the time information. For example, if a phrase, “time period”, is used in the source file, chances are high that subsequent description is information specifying a time, such as a time period of some event.

The same can be said for a phrase, “date and time”. Moreover, such phrases as “open”, “start”, “opening curtain”, “the first train of the day”, “open shop”, “close”, “end”, “last curtain”, “the last train”, “closed”, “from”, “˜”, “−”, “o'clock”, “:”, “minutes”, “year”, “month”, “date” etc. fall under the category of the time recall phrase. When a new time recall phrase is discovered, the phrase is added to the time recall phrase list 48 and updated, whereby extraction of the time information becomes easier.

The above-described are the lists that are used in constructing the browse history DB 33. The browse history DB 33 will now be described.

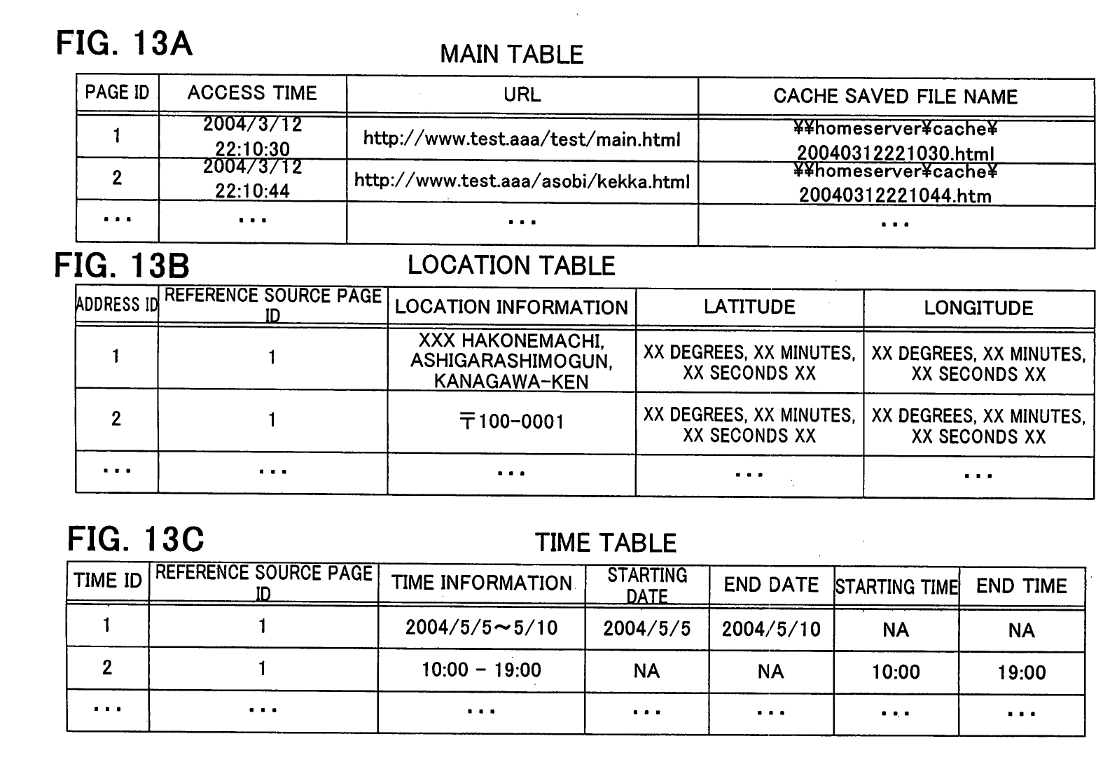

FIG. 13 is a data configuration example of the browse history DB 33 used in the specific example of the present embodiment. FIG. 13A is a main table 51 in which a URL of a website browsed using the home terminal 101 and a storage location of a source file are corresponded to each other and then stored. FIG. 13B is a location table 52 in which location information, which is extracted by analyzing the contents of the source file, and the website stored in the browse history DB 33 are corresponded to each other, and stored, and FIG. 13C is a time table 53 in which the time information, which is extracted by analyzing the contents of the source file, and the website stored in the browse history DB 33 are corresponded to each other, and stored.

The main table 51 of FIG. 13A has data items, such as “page ID”, “access time”, “URL”, and “cache saved file name”. The “page ID” is an identifier for specifying the website that is saved as a browse history. The “access time” indicates a time when the website saved as the browse history is browsed using the home terminal 101.

The “URL” is a URL of the website that is saved as the browse history. The “cache saved file name” is a path name that indicates a storage location of the source file of the website saved as the browse history in the server 1.

The location table 52 of FIG. 13B has data items, such as “address ID”, “reference source page ID”, “location information”, “latitude”, and “longitude”. The “address ID” is an identifier for specifying an extracted location. The “reference source page ID” indicates a page ID for specifying a website where the location information is extracted. For example, FIG. 13B shows two location information items that are extracted from a website (URL=www.test.aaa/test/main.html) whose page ID of FIG. 13A is 1.

The “location information” indicates phrases of the extracted location information. The “latitude” and “longitude” indicate latitude and longitude obtained by converting the extracted location information on the basis of the lists provided in FIG. 7 to FIG. 10. For example, in the case of the location information whose address ID of FIG. 13B is 1, latitude/longitude of “Hakonemachi” (in FIG. 8 not shown) stored in the city/town/village name list (FIG. 8) is stored (in this case, although it also matches “Kanagawa-ken” of the prefecture name list (FIG. 7), latitude/longitude of the more detailed city/town/village name, which is “Hakonemachi”, is used as a priority). Further, in the case of the address information whose address ID of FIG. 13B is 2, latitude and longitude of “100-0001” stored in the zip code list (FIG. 10) are stored.

The time table 53 of FIG. 13C has data items, such as “time ID”, “reference source page ID”, “time information”, “starting date”, “end date”, “starting time”, and “end time”. The “time ID” is an identifier for specifying an extracted time. The “reference source page ID” indicates a page ID for specifying a website where the time information is extracted. For example, FIG. 13C shows two time information items that are extracted from the website (URL=www.test.aaa/test/main.html) whose page ID of FIG. 13A is 1.

The “time information” indicates a phrase of the extracted time information. The “starting date”, “end date”, “starting time”, and “end time”, are obtained by splitting the extracted time information into starting point of time and end point of time.

Finally, the list to be used when processing the information search request sent from the user will now be explained.

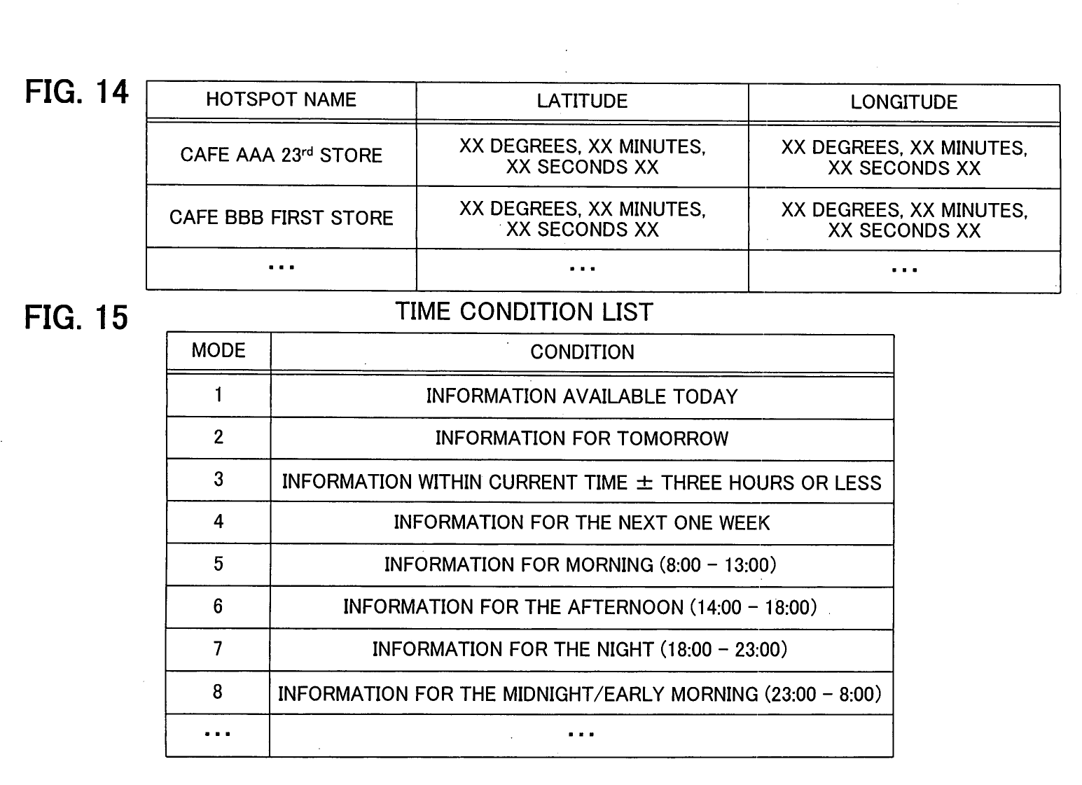

FIG. 14 is a data configuration example of a hotspot name list 49 which is used in the specific example of the present embodiment. This list is referred to when the present location (or destination) of the user is specified by means of an access point name (hotspot name) of the wireless LAN in order to retrieve information from the browse history of the server 1 in a place where the user is happened to be.

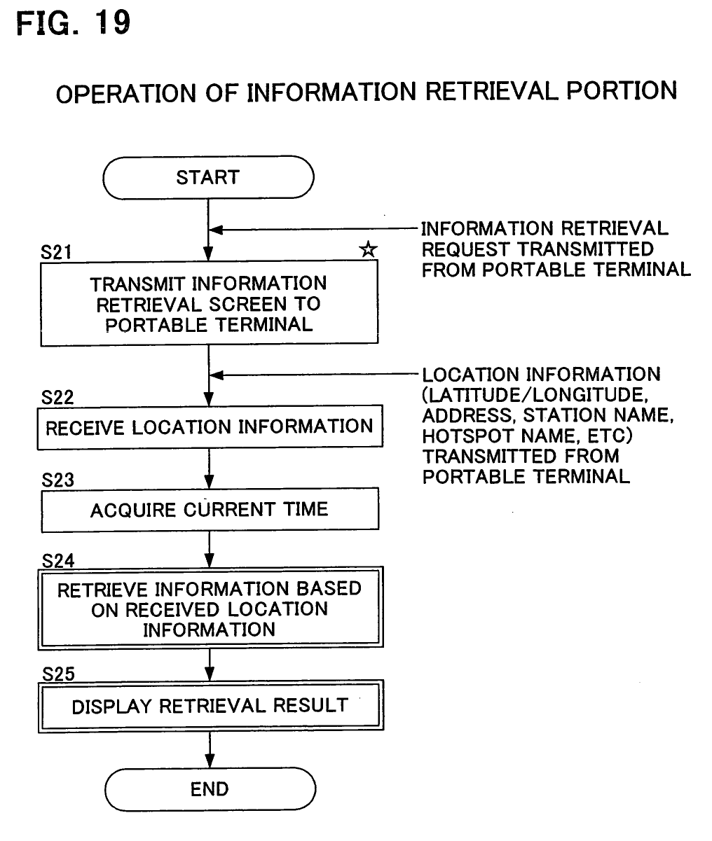

The hotspot name list 49 of FIG. 14 has data items, such as “hotspot name”, “latitude”, and “longitude”. In this specific example, a hotspot name selected by the user is converted into latitude/longitude and is processed by the server 1, latitude and longitude are corresponded to each hotspot name in the list 49. Latitude and longitude corresponding to the hotspot name are determined in advance based on the street address of the hotspot. Now, FIG. 19 and the following explanation explain how the information retrieval processing is performed where the server 1 responds with the information stored in the browse history DB with respect to the location designated by the user.

FIG. 15 is a data configuration example of a time condition list 50 used in the specific example of the present embodiment. This list is referred to when determining a time condition related to the browse history presented to the user.

The time condition list 50 of FIG. 15 has data items, such as “mode”, and “condition”. The “mode” is a number for identifying each time condition. In this specific example, the information for specifying a mode for the time is stored in advance in the storage portion 13 of the server 1.

The “condition” indicates a condition for selecting depending on time the contents written in the website related to the location designated by the user. For example, in the case of mode 1, the URL of a website where the contents thereof has a description of information related to the date of the day, which is sent as a response to the user, the website being related to the location designated by the user.

These are the data configurations of various lists 34 and the browse history DB 33 that are used. Next, operation of each functional portion will now be described.

FIG. 16 is a flow chart for explaining an operation of the browse history analysis portion 31 in the specific example of the present embodiment. First, the browse history analysis portion 31 receives the URL of the website browsed from the home terminal 101, and a source file, and analyzes the XML tag contained in the source file (S1). This is a process performed with respect to the rule number 1 of the location information extraction rule list 41 (see FIG. 5), where it is judged whether or not the phrase contained in the location recall phrase list 42 is used as the XML tag.

When the phrase contained in the location recall phrase list 42 is used as the XML tag (S2 Yes), the browse history analysis portion 31 temporarily stores the location information into the RAM 12 of the server 1 (S3). In the step S3 the contents enclosed in the XML tags are extracted as the location information on the basis of the “extraction method” of the location information extraction rule list 41 (FIG. 4). When the phrase contained in the location recall phrase list 42 is not used as the XML tag (S2 NO), the step S3 is omitted.

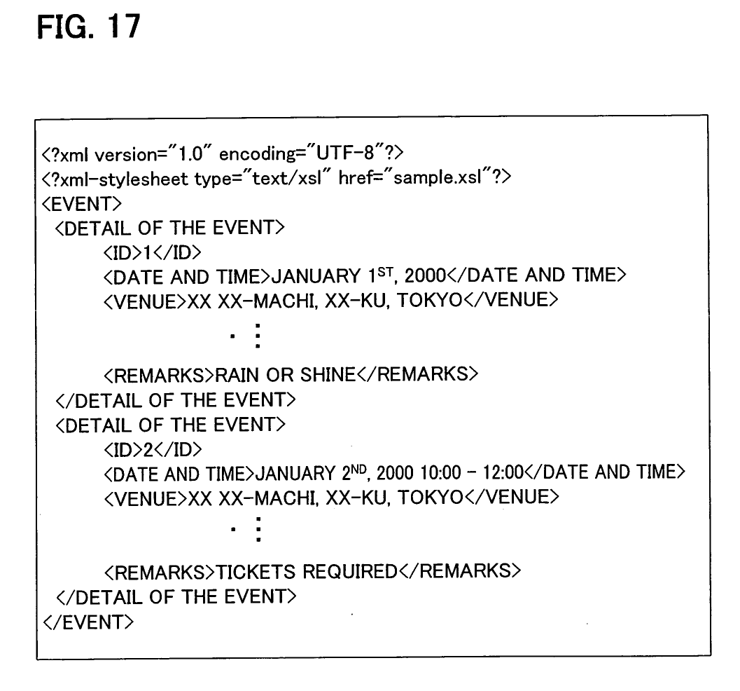

FIG. 17 is a specific example of the source file where the location recall phrase is used for the tag. In this source file, “venue” that is contained in the location recall phrase list 42 (see FIG. 6) is used as the XML tag. Therefore, in the processing of the step S3, the contents enclosed in <venue>, and </venue> are extracted respectively as the location information.

Looking at FIG. 16 again, it shows that after analysis of the XML tags, the phrases in the body text of the source file are analyzed (S4). The step S4 is to judge and see if the location recall phrase is used in a place other than the tag, and is performed with respect to the rule number 2 and the following numbers of the location information extraction rule-list 41 (see FIG. 5). Then, it is judged whether or not a prefecture name is contained in the body text of the source file.

When the prefecture name is contained (S5 Yes), the browse history analysis portion 31 stores the location information temporarily in the RAM 12 of the server 1 (S6). In the step S6, a matched phrase, that is, the prefecture name contained in the source file, is extracted as the location information on the basis of the “extraction method” of the location information extraction rule list 41 (FIG. 5).

Hereinafter, if a plurality of rules are set in the location information extraction rule list 41 (FIG. 5), extraction of the location information about, for example, a city/town/village name or station name, is performed based on these rules, as with a prefecture name. When there exists a phrase contained in the location recall phrase list 42 at the place other than the tag, the location information extracted in the step S6 is the contents in the matched line and the line next thereto.

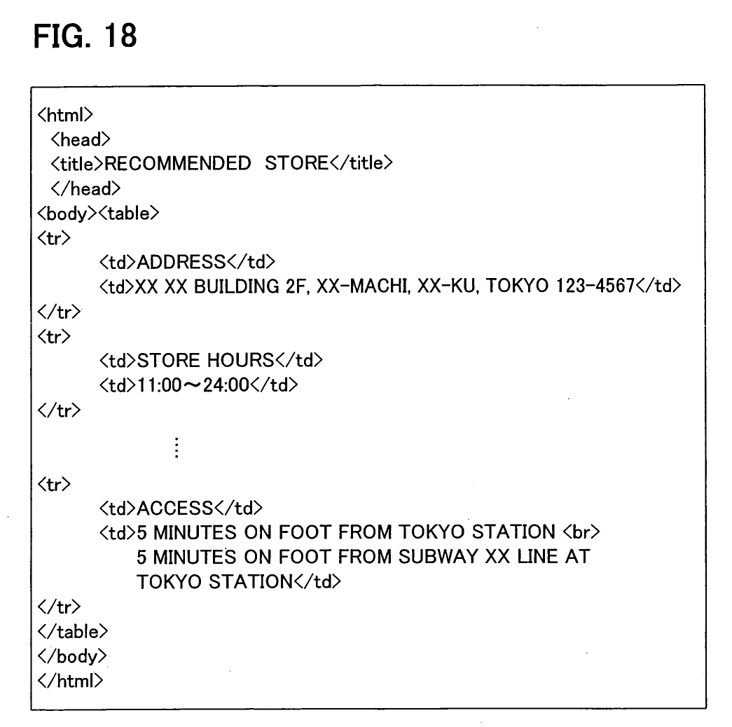

FIG. 18 is a specific example of the source file where the location recall phrases is used in a place other than the tag. The source file shown in FIG. 18 does not contain the XML tags, thus no location information is extracted in the processing of the steps S1 to S3. Further, “Tokyo” is extracted as the phrase contained in the prefecture name list 43, and “xx-ku, Tokyo” is extracted as the phrase contained in the city/town/village name list 44. Furthermore, “Tokyo Station” is extracted as the phrase contained in the station name list 45, the contents in the line where “address” that is contained in the location recall phrase list 42 is used and the line next thereto (T 123-4567 xx Building 2F, xx, xx machi, xx-ku, Tokyo) is extracted. Moreover, the content in the line where “ [symbol] ” is used contained in the location recall phrase list 42, and the line next thereto is extracted, and furthermore these are stored in the RAM 12.

Looking at FIG. 16 again, it is shown that after the extraction of the location information from the source file, the browse history analysis portion 31 extracts time information on the basis of the time information extraction rule list 47 (FIG. 11) (S7). The extraction of time information and the extraction of location information are substantially the same. First, it is judged whether or not the phrase contained in the time recall phrase list 48 is used as the XML tag, and, if used, (S7 Yes), the browse history analysis portion 31 temporarily stores the contents enclosed in the XML tags in the RAM 12 of the server 1 on the basis of “extraction method” of the time information extraction rule list 47 (FIG. 11) (S8).

If a plurality of rules are set in the time information extraction rule list 47 (FIG. 11), the next rule is applied. For example, it is judged whether or not the phrase contained in the time recall phrase list 48 is used in a place other than the tag, and, if used (S7 Yes), the browse history analysis portion 31 temporarily stores the contents of the matched line and the line next thereto into the RAM 12 of the server 1 on the basis of the “extraction method” of the time information extraction rule list 47 (FIG. 11) (S8).

After application of all the rules is completed, the browse history analysis portion 31 further attempts to split the extracted time information into a starting date and end date, or into a starting time and end time. This action judges whether or not it is possible to split them by using such phrases as “from”, “˜”, “−” or the like. If it is possible to split them by these phrases, there is applied a standard of judgment regarding whether a year, month, and date are included or not, or whether such a data format as yyyy/mm/dd (where yyyy indicates a Christmas year, mm indicates a month, and dd indicates a date) is used or not, etc., to classify the split time information into starting date or starting time for the first half, and end date or end time for the last half.

Of course, other classification methods besides above may be applied to split the time information into starting date and end date, or into starting time and end time. Further, when a single time is written or when the relevant information is not written, the browse history analysis portion 31 stores the extracted time information in “time information” of the time table 53 of the browse history DB 33, and stores “NA” appropriately for other items (“starting date”, “end date”, “starting time”, and “end time”).

Next, the browse history analysis portion 31 judges whether or not the location information is stored in the RAM 12 in above processing (S9), and if there is any location information in the RAM 12 (S9 Yes), converts the location information into latitude/longitude information (S10). In the processing of the step S10, it is only necessary for the browse history analysis portion 31 to use the lists shown in FIG. 7 to FIG. 10 to convert the phrases stored in the RAM 12 into latitude/longitude. Note that, in the step S10, when a line, but not a phrase, of the source file is extracted as the location information (in the case where the rule number 5 of FIG. 5 is applied, etc.), the browse history analysis portion 31 judges whether or not if the names shown in FIG. 7 to FIG. 10 (prefecture name, city/town/village name, station name, zip code) are contained in the contents of the line, and uses the latitude/longitude information corresponding to the matched phrase.

After the step S10 is finished, the browse history analysis portion 31 stores the time information extracted in the step S8 and the location information converted into latitude/longitude in the step S10 into the browse history DB, along with the source file and URL received in the step S1 (S11). The browse history analysis portion 31 repeats the processing of the steps S1 to S11 every time receiving source file and URL as the browse history from the home terminal 101. Consequently, the tables as shown in FIG. 13A to C are created.

Next, an operation of the information retrieval portion 32 will be described.

FIG. 19 is a flow chart for explaining an operation of the information retrieval portion 32 in the specific example of the present embodiment. The information retrieval portion 32 of this specific example functions as a web server, and transmits a data to display an information retrieval screen in response to an information retrieval request transmitted from a portable terminal (S21).

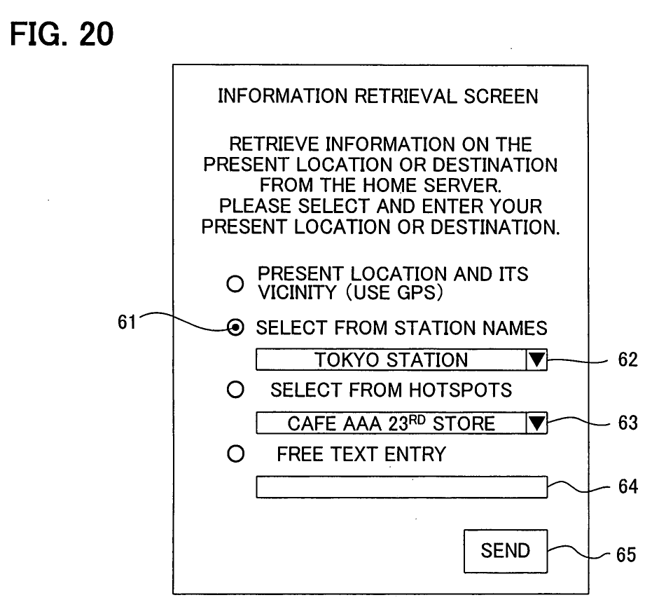

FIG. 20 is an example of the information retrieval screen in the step S21. In FIG. 20, there are four radio buttons 61, with which location information for specifying a present location or destination is inputted to the server 1 in accordance with a selection of the user. By selecting the very top radio button of FIG. 20 and clicking a send button 65, latitude/longitude information of the present location identified by the GPS function installed in the portable terminals 102 and 103 is transmitted to the server 1. In this way, the user acquires the information on the vicinity of the present location, which is stored in the server 1.

In addition, by selecting the second radio button and clicking the send button 65, the station names displayed in a pull-down menu 62 at that time are transmitted to the server 1. Therefore, the user selects a station name of the present location or destination from the pull-down menu in advance, and clicks the send button 65, to acquire the information on the vicinity of the desired station, which is stored in the server 1.

By selecting the third radio button and clicking the send button 65, the hotspot names displayed in a pull-down menu 63 at that time are transmitted to the server 1. Therefore the user selects a hotspot name of the present location or destination from the pull-down menu in advance, and clicks the send button 65, to acquire the information on the vicinity of the desired hotspot, which is stored in the server 1.

By selecting the fourth radio button and clicking the send button 65, the text entered in a form (text field) 64 at that time is transmitted to the server 1. Therefore, the user enters an address of the present location or destination in advance and clicks the send button 65, to acquire the information on the vicinity of the desired address, which is stored in the server 1.

Looking at FIG. 19 again, it is shown that, after the step S21, the information retrieval portion 32 receives the location information from the portable terminal (S22). Based on the radio button selected by the user, as described above, the information retrieval portion 32 receives corresponding location information. Then, the information retrieval portion 32 acquires a current time (S23). The information retrieval portion 32 may acquire the time from a clock (not shown) built into the server 1, or may acquire the time from an NTP (Network Time Protocol) time server on the network.

The information retrieval portion 32 then performs information retrieval based on the location information received in the step S22 (S24), generates screen data for displaying a retrieval result to the portable terminal, and transmits it to the portable terminal (S25).

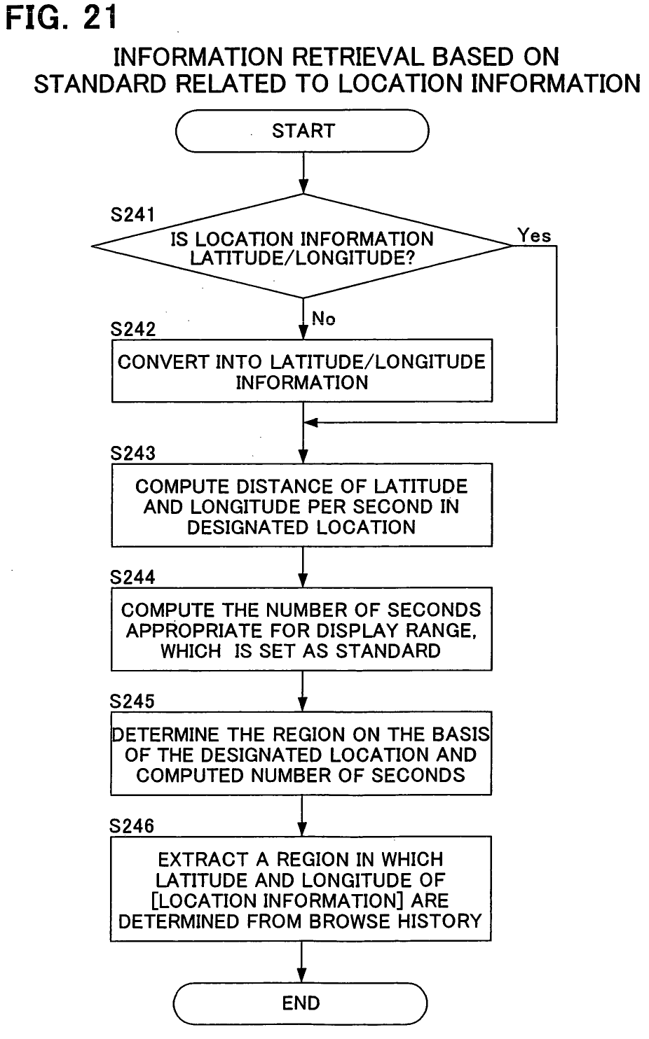

FIG. 21 is a flow chart for explaining the information retrieval processing on the basis of the location information of the step S24 in the specific example of the present embodiment. A region of latitude/longitude for which the information should be retrieved is defined on the basis of a value obtained by converting the location, which is designated by the user, into latitude/longitude, and of a retrieval range that is set beforehand. Further, the location information contained in this region is extracted from the location table 52, and the corresponding URL is presented to the user.

The information retrieval portion 32 judges whether or not the received location information is latitude/longitude (S241). When the user selects something other than “the vicinity of the present location (using GPS)” on the screen shown in FIG. 20, the location information transmitted is not latitude/longitude.

When the received location information is not latitude/longitude (S241 No), the information retrieval portion 32 converts the received location information into latitude/longitude information (S242). For example, when a station name is received as the location information, the station name can be converted into latitude/longitude by referring to the station name list 45 of FIG. 9. When a hotspot name is received as the location information, the hotspot name can be converted into latitude/longitude by referring to the hotspot name list 49 of FIG. 14.

Further, when an address is received as the location information, latitude and longitude are specified in the order of the zip code list 46 of FIG. 10, the city/town/village name list 44 of FIG. 8, and the prefecture name list 43 of FIG. 7. Specifically, it is judged first whether or not a zip code is included in the received address, and if included, the received address is converted into corresponding latitude/longitude on the basis of the zip code list of FIG. 10. Next, it is judged whether or not a city/town/village name is included, and if included, the received address is converted into corresponding latitude/longitude on the basis of the city/town/village name list of FIG. 8.

At last, it is judged whether or not a prefecture name is included, and if included, the received address is converted into corresponding latitude/longitude on the basis of the prefecture name list of FIG. 7. By judging first whether or not there is a component to specify more detailed latitude/longitude, a retrieval result tends to comply with the interest of the user.

When the location information is received in the form of latitude/longitude (S241 Yes), the processing of the step S242 is skipped. When conversion into latitude/longitude is finished, the information retrieval portion 32 computes the distance of latitude/longitude per second in a designated position (S243). For example, suppose that a certain location (at latitude x1 degrees, x2 minutes north, and longitude y1 degrees, y2 minutes east) has a latitude of 30 m/second, and longitude of approximately 25 m/second.

The information retrieval portion 32 computes the number of seconds appropriate for the retrieval range set as a standard (S244). The set retrieval range is stored in the storage potion 13 of the server 1 in advance, and is assumed as, for example, 500 square meters. In the case of the location described above, the latitude is obtained as 500/30=16.67 seconds, and the longitude is obtained as 500/25=20 seconds. Note that the retrieval range may be indicated by the variables that can be set by the user. In this case, the radio button 61 for changing the setting is added onto the information retrieval screen (see FIG. 20) which is transmitted by the server 1 in the step S21, and it is only necessary to allow the user to enter the distance on one side of the retrieval range in meters into a form for inputting a numeric value.

The information retrieval portion 32 then determines the region on the basis of the latitude and longitude of the location designated in the step S242 and on the basis of the number of seconds computed in the step S243 (S245). For example, in the case of the location described above, a grid-like region defined by four points is determined in the step S245, the four points being (latitude of x1 degrees, x2 minutes north−8.335 seconds, and longitude of y1 degrees, y2 minutes east−10 seconds), (latitude of x1 degrees, x2 minutes north+8.335 seconds, and longitude of y1 degrees, y2 minutes east−10 seconds), (latitude of x1 degrees, x2 minutes north−8.335 seconds, and longitude of y1 degrees, y2 minutes east+10 seconds), (latitude of x1 degrees, x2 minutes north+8.335 seconds, and longitude of y1 degrees, y2 minutes east+10 seconds).

Furthermore, the information retrieval portion 32 extracts the browse histories in which the region determined in the step S245 contains the latitude/longitude of the location information extracted from the browse history (S246). The information retrieval portion 32 refers to the location table 52 of the browse history DB 33 to extract the browse histories in which the region determined in the step S245 contains the above latitude/longitude (see FIG. 13B), and to acquire the reference source page ID thereof, and completes the information retrieval processing.

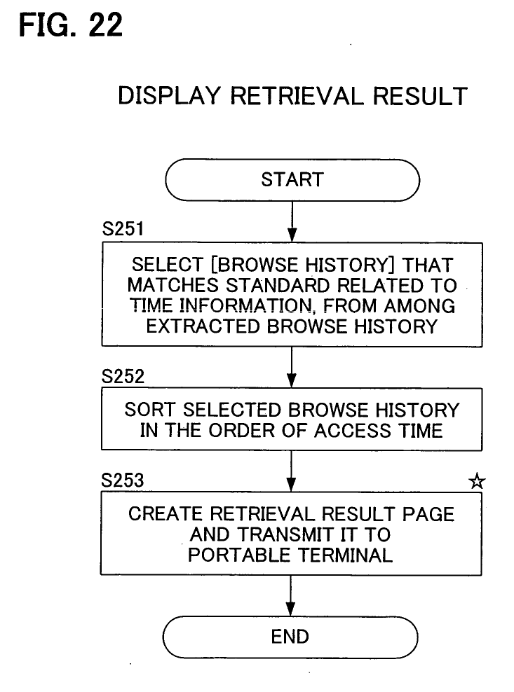

FIG. 22 is a flow chart for explaining the retrieval result display processing of the step S25 in the specific example of the present embodiment. In the present embodiment, the browse history presented to the user is narrowed by selecting a browse history that is appropriate to the standard related to the time information, from among the browse histories extracted in the step 5246. Specifically, selecting in accordance with a mode is performed based on the time condition list 50.

First of all, the information retrieval portion 32 selects a browse history that is appropriate to the standard related to the time information, from among the browse histories extracted in the step S246 (S251). The information retrieval portion 32 acquires a mode related to the time, refers to the time condition list 50, and acquires “condition” corresponding to the mode. The information retrieval portion 32 then extracts entries having the same “reference source page ID” as the reference source page ID extracted in the step S246, by means of the time table 53. The entries, “time information”, “starting date”, “end date”, “starting time”, and “end time”, are used in order to ultimately present an entry that matches the “condition” corresponding to the mode, as an information retrieval result for the user, on the basis of the present time acquired in the step S23.

The browse history selected in the step S251 is sorted in the order of access time (S252), and the information retrieval portion 32 acquires the title and an access date and time that correspond to the finally selected URL by referring to the main table of the browse history DB, creates a retrieval result page for displaying the obtained information retrieval result and transmits it to the portable terminal (S253).

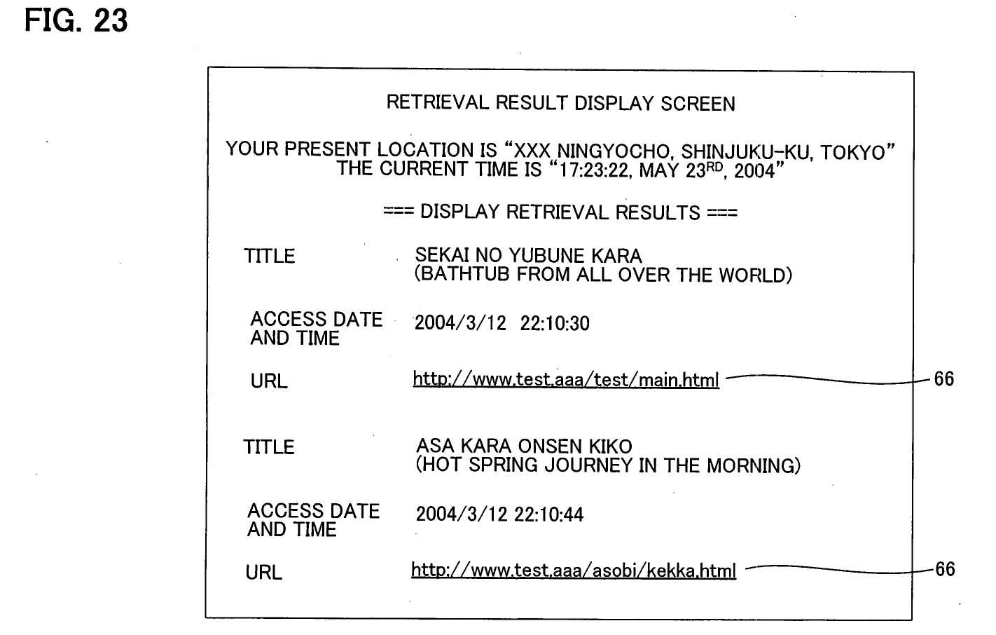

FIG. 23 is an example of the information retrieval result display screen in the specific example of the present embodiment. The URL of the browse history, title and an access date and time that are extracted in the step S246 and that meet the condition of the time condition list in the step S251 are displayed as the information retrieval result. The URL is displayed in hyperlink 66. Thus, the user can click on the hyperlink 66 to easily move to the relevant website and acquire the information. In this case, the content of the cache stored in the server 1 can be set so as to be presented to the user, or can be set so that the latest information is acquired by actually accessing the Internet.

Note that a desktop PC, PDA or the like may be used as the home terminal of this specific example. Similarly, a desktop PC or a portable notebook PC that is installed in a place wherever the user is happened to be (a hotel, for example) may be used as the portable terminal.

Further, in this specific example, the hotspot name list 49 is used only for specifying the present location (or destination) of the user; however, it can also be used for extracting the location information, as with the case of the station name list 45 and the like. Contrary, the prefecture name list 43, city/town/village name list 44, and station name list 45 that are used for extracting the location information in the present embodiment may be used for specifying the present location (or destination) of the user. In addition, the facility name list that provides well-known facilities (e.g. Tokyo Tower, Yokohama Arena and the like) can be used for extracting the location information and for specifying the present location (or destination).

Moreover, in this specific example, although the location information and time information are combined and used, they can be used independently as a predetermined subject. Further, not only the location information and time information, but also various objects can be used as the subject. For example, “dog”, “cat”, “Japanese trains” and the like can be used. For each of the subjects, a list of phrases that are likely to be followed by phrases recalling the subject are created and stored in advance, and the browse history analysis portion 31 extracts information, in conformity to this list. If the user wishes to acquire information about, for example, a dog Chihuahua, the user provides “chuihuahua” to the server 1, if the user wishes to acquire information about Persian cat, the user provides “Persian cat” to the server 1, and if the user wishes to acquire information about “Shinkansen bullet train”, the user provides “Shinkansen bullet train”, whereby the user can easily obtain the URL of the website containing related information, on the basis of the user's own browse history.

As above, by using the present browse history presentation system, information about a predetermined subject which is set in advance is extracted from a website browsed using the home terminal 101, which is then corresponded to the URL and accumulated in the server 1. Even from a place wherever the user is happened to be, by inputting a field that subclassed in the predetermined subject (specific values or phrases related to the predetermined subject), the user can easily acquire the URL and the like of the website that the user has browsed before, from among the websites that contain the related information, and the relevant website can be displayed by a simple click. Therefore, wherever the user is happened to be, it is possible to effectively utilize the information collected at home or at workplace.

What is claimed is:

1. An information processing device, comprising:
a browse history analysis portion which extracts information conforming with a predetermined subject from received data of a first device, and relates said information with reference data of said received data to store the related data in a storage portion; and
an information retrieval portion which receives an information retrieval request sent from a second device, along with a designation of a field subclassed in said predetermined subject, retrieves the information conforming with said predetermined subject stored in said storage portion, extracts said reference data corresponding to said designated field, and transmits the extracted reference data to said second device.

2. The information processing device according to claim 1, wherein:
said storage portion has stored therein, in advance, a subject recall phrase list containing a phrase that is likely to be followed by a description of the information conforming with said predetermined subject; and
said browse history analysis portion judges whether or not the phrase contained in said subject recall phrase list is used for a tag name within said received data, and, if used, stores the content of the tag in which the phrase contained in said subject recall phrase list is used for said tag name, as the information conforming with said predetermined subject.

3. The information processing device according to claim 1, wherein:
said storage portion has stored therein, in advance, the subject recall phrase list containing a phrase that is likely to be followed by a description of the information conforming with said predetermined subject; and
said browse history analysis portion judges whether or not the phrase contained in said subject recall phrase list is used in said received data, and, if used, stores the contents of the line in which the phrase contained in said subject recall phrase list is used, and/or of the line next thereto, as the information conforming with said predetermined subject.

4. The information processing device according to claim 1, wherein:
the information conforming with said predetermined subject is location information for specifying a location;
said field designation is a designation of a predetermined location; and
said information retrieval portion retrieves said storage portion on the basis of said location information to extract said reference data corresponding to said predetermined location.

5. The information processing device according to any of claims 1 to 3, wherein:
the information conforming with said predetermined subject is time information for specifying a time;
said field designation is a designation of a predetermined time; and
said information retrieval portion retrieves said storage portion on the basis of said time information to extract said reference data corresponding to said time information.

6. The information processing device according to claim 4, wherein:
said storage portion has stored therein, in advance, a location recall phrase list containing a phrase that is likely to be followed by a description of said location information, latitude/longitude information in which an address and latitude/longitude are corresponded to each other, and range information for determining a retrieval range of the vicinity of said designated location;
said browse history analysis portion judges whether or not the phrase contained in said location recall phrase list is used for a tag name within said received data, and, if used, extracts said address from the content of the tag in which the phrase contained in said location recall phrase list is used for said tag name, converts the extracted address into latitude/longitude on the basis of said latitude/longitude information, and stores the converted result as said location information; and
said information retrieval portion receives information for specifying latitude/longitude as a designation of said location, and extracts said reference data corresponding to said retrieval range which is determined based on said range information.

7. The information processing device according to claim 6, wherein, when receiving information for specifying an address as a designation of said location, said information retrieval portion converts the address specified by the received information into latitude/longitude on the basis of said latitude/longitude information to perform retrieval.

8. The information processing device according to claim 6, wherein any of a prefecture name, city/town/village name, zip code, facility name, access point name of a wireless LAN, or station name is used as said address.

9. A program causing a computer to execute:
extracting information conforming with a prescribed subject from received data of a first device;
relating said information with reference data of said received data to store the related data in a storage portion;
receiving an information retrieval request sent from a second device, along with a designation of a field subclassed in said predetermined subject;
retrieving the information conforming with said predetermined subject stored in said storage portion,
extracting said reference data corresponding to said designated field; and
transmitting the extracted reference data to said second device.

10. The program according to claim 9, wherein:
said storage portion has stored therein, in advance, a subject recall phrase list containing a phrase that is likely to be followed by a description of the information conforming with said predetermined subject; and
said information conforming with said predetermined subject is a content of a tag in which the phrase contained in said subject recall phrase list is used for said tag name.

11. The program according to claim 9, wherein:
said storage portion has stored therein, in advance, the subject recall phrase list containing a phrase that is likely to be followed by a description of the information conforming with said predetermined subject; and
said information conforming with said predetermined subject is a content of a line in which the phrase contained in said subject recall phrase list is used, and/or of the line next thereto.

12. The program according to claim 9, wherein:
the information conforming with said predetermined subject is location information for specifying a location;
said field designation is a designation of a predetermined location;
said retrieving is performed to retrieve on the basis of said location information; and
said extracting is performed to extract said reference data corresponding to said predetermined location.

13. The program according to claim 9, wherein:
the information conforming with said predetermined subject is time information for specifying a time;
said field designation is a designation of a predetermined time;
said retrieving is performed on the basis of said time information; and
said extracting is performed to extract said reference data corresponding to said time information.

14. The program according to claim 12, wherein:
said storage portion has stored therein, in advance, a location recall phrase list containing a phrase that is likely to be followed by a description of said location information, latitude/longitude information in which an address and latitude/longitude are corresponded to each other, and range information for determining a retrieval range of the vicinity of said designated location;
said extracting is performed to extract said address from a content of a tag in which the phrase contained in said location recall phrase list is used for said tag name within said received data;
said location information is the converted result of the extracted address into latitude/longitude on the basis of said latitude/longitude information;
said receiving is performed to receive information for specifying latitude/longitude as a designation of said location; and
said extracting is performed to extract said reference data corresponding to said retrieval range which is determined based on said range information.

15. The program according to claim 14, wherein, when receiving the information for specifying an address as a designation of said location, said retrieving is performed using a converted result of the address specified by the received information on the basis of said latitude/longitude information.

16. The program according to claim 14, wherein said address is any of a prefecture name, city/town/village name, zip code, facility name, access point name of a wireless LAN, or station name.

17. A browse history presentation method, comprising:
extracting information conforming with a predetermined subject from received data of a first device;
relating said information with reference data of said received data to store the related data in a storage portion;
receiving an information retrieval request sent from a second device, along with a designation of a field subclassed in said predetermined subject;
retrieving the information conforming with said predetermined subject said storage portion;
extracting said reference data corresponding to said designated field; and
transmitting the extracted reference data to said second device.

18. The browse history presentation method according to claim 17, wherein:
said storage portion has stored therein, in advance, a subject recall phrase list containing a phrase that is likely to be followed by a description of the information conforming with said predetermined subject; and
said information conforming with said predetermined subject is a content of a tag in which the phrase contained in said subject recall phrase list is used for said tag name.

19. The browse history presentation method according to claim 17, wherein:
said storage portion has stored therein, in advance, the subject recall phrase list containing a phrase that is likely to be followed by a description of the information conforming with said predetermined subject; and
said information conforming with said predetermined subject is a content of a line in which the phrase contained in said subject recall phrase list is used, and/or of the line next thereto.

20. The browse history presentation method according to claim 17, wherein:
the information conforming with said predetermined subject is location information for specifying a location;
said field designation is a designation of a predetermined location;
said retrieving is performed to retrieve on the basis of said location information; and
said extracting is performed to extract said reference data corresponding to said predetermined location.

21. The browse history presentation method according to claim 17, wherein:
the information conforming with said predetermined subject is time information for specifying a time;
said field designation is a designation of a predetermined time;
said retrieving is performed on the basis of said time information; and
said extracting is performed to extract said reference data corresponding to said time information.

22. The browse history presentation method according to claim 20, wherein:
said storage portion has stored therein, in advance, a location recall phrase list containing a phrase that is likely to be followed by a description of said location information, latitude/longitude information in which an address and latitude/longitude are corresponded to each other, and range information for determining a retrieval range of the vicinity of said designated location;
said extracting is performed to extract said address from a content of a tag in which the phrase contained in said location recall phrase list is used for said tag name within said received data;
said location information is the converted result of the extracted address into latitude/longitude on the basis of said latitude/longitude information;
said receiving is performed to receive information for specifying latitude/longitude as a designation of said location; and
said extracting is performed to extract said reference data corresponding to said retrieval range which is determined based on said range information.

23. The browse history presentation method according to claim 22, wherein, when receiving the information for specifying an address as a designation of said location, said retrieving is performed using a converted result of the address specified by the received information on the basis of said latitude/longitude information.

24. The browse history presentation method according to claim 22, wherein said address is any of a prefecture name, city/town/village name, zip code, facility name, access point of a wireless LAN, or station name.
